(19) United States
(12) Patent Application Publication
(10) Pub. No.: US 2005/0155807 A1
(43) Pub. Date: Jul. 21, 2005

(54) Vehicle with an internal combustion engine and an axle carrier

(76) Inventors: Klaus Haegele, Heuchlingen (DE); Fritz Wazula, Aidlingen (DE); Erwin Wogh, Kirchheim (DE)

Correspondence Address: PENDORF & CUTLIFF, 5111 MEMORIAL HIGHWAY, TAMPA, FL, 33634-7356, US

(21) Appl. No.: 10/506,761

(22) PCT Filed: Feb. 19, 2003
(86) PCT No.: PCT/EP03/01647

(30) Foreign Application Priority Data
Mar. 8, 2002 (DE) 102 10 127.2

(51) Int. Cl. B60K 3/00

(52) U.S. Cl. 180/299

(57) ABSTRACT

The invention relates to a vehicle having an internal combustion engine and an axle carrier on which this is mounted. In order to enable even very powerful engines to be used without unduly increasing the loads upon the regions of the vehicle adjacent to the engine compartment and the environmental pollution load, it is proposed that the axle carrier has on its top side at least one protective lining.

### BACKGROUND OF THE INVENTION

1. Field of Invention

The invention relates to a vehicle having an internal combustion engine as defined in the preamble to patent claim 1.

2. Related Art of the Invention

The current progressive development of ever more powerful internal combustion engines in motor vehicles is accompanied, in their running, by a massive increase in waste heat from the engine, in noise development and in induced vibrations of neighboring components, especially under full load. These accompanying phenomena place a heavy load on the regions adjacent to the engine compartment. In this context, the automotive manufacturers are bound by statutory provisions not to promote noise pollution through engine running. The induced vibration can lead, in turn, to a chafing of closely spaced components, especially in respect of supply lines, resulting in increased wear for these components.

### SUMMARY OF THE INVENTION

The object of the invention is to refine a vehicle of the generic type to the effect that even very powerful engines can be used without unduly increasing the loads upon the regions of the vehicle adjacent to the engine compartment and upon the outside world.

The object is achieved according to the invention by virtue of the features of patent claim 1.

Owing to the invention, as a result of the protective lining on a protruding component surrounding the engine, such as the axle carrier, the so-called “integral carrier”, noises, waste heat and induced vibrations resulting from the engine running is extensively dampened close to the engine with no great space-restricting consequences for the engine, auxiliaries and other supply-relevant components. Because of the proximity to the engine, the propagation of noises and waste heat is curbed early in the process. Accordingly, the outside world will at most perceive—if at all—a slight increase in pollution. High-performance engines can thus be used without having to accept harmful consequences into the bargain. In the same context, in smaller, less powerful engines whose noise emission, waste heat and induced vibrations are significantly lower, materials can be used which, because of the protective lining in other components, have no need to exhibit special properties in terms of heat resistance or wearing resistance and are hence cheaper. If need be, the surrounding components can also be placed closer to the engine without risk of damage, thereby enabling a more compact construction of the entire vehicle section containing the engine. Furthermore, because of the protective lining, the actual axle carrier body can be safely made from lightweight materials, such as aluminum, for example, which are sensitive to high temperatures. Moreover, the invention is not limited solely to said integral carrier. As is generally known, there are also vehicles without an integral carrier, in which its function is assumed by crossmembers. To this effect, the inventive lining of these crossmembers is also conceivable.

### BRIEF DESCRIPTION OF THE DRAWINGS

Expedient embodiments of the invention can be derived from the subclaims; in addition, the invention is explained in greater detail below with reference to two illustrative embodiments represented in the drawings, in which:

FIG. 1 shows in a top view an axle carrier according to the invention with fully lined longitudinal sides,

FIG. 2 shows in a perspective view a portion of the axle carrier according to the invention having a part-lining of the longitudinal sides of the axle carrier.

### DETAILED DESCRIPTION OF THE INVENTION

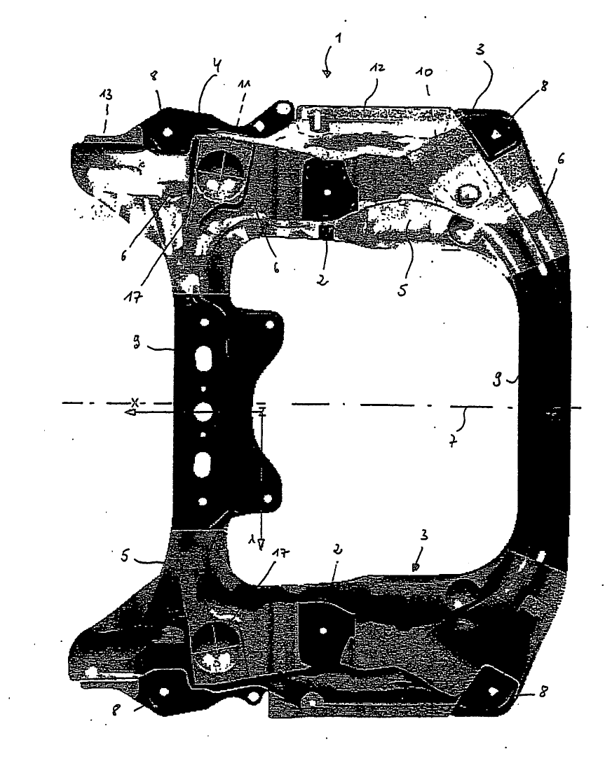

FIG. 1 shows an axle carrier 1 of a vehicle having an internal combustion engine, which engine is mounted thereon at points on the longitudinal sides 3 of the axle carrier 1 which are configured as an engine mount 2. The actual axle carrier 1 consists of steel or aluminum and has on its top side 4 a protective lining 5. In this illustrative embodiment, the protective lining is screwed to the axle carrier 1 at fastening points 6. However, the lining 5 can also be glued or clipped on the axle carrier 1. The two longitudinal sides 3 of the axle carrier 1, extending parallel to the vehicle longitudinal axis 7, are fully covered by means of the lining 5, with the exception of the fastening points 8, for fastening to a longitudinal member of the vehicle, and the engine mount 2. This has the advantage that the region of the axle carrier 1 which is relevant to the engine waste heat and the regions of the vehicle which are adjacent to the engine compartment are optimally screened with respect to engine noise emission, engine waste heat and induced vibrations. It is certainly conceivable that, in place of the full lining 5, a plurality of individual linings for different regions at individual cover points on the axle carrier 1 can be used. The one-piece joint between the individual linings, which joint is integrated with the full lining 5, yields the production engineering advantage of the integrality of the component to be built, i.e. the lining 5, thereby minimizing the number of manufacturing tools and the process time. Furthermore, the multiplicity of fastening points to be provided in respect of individual linings are no longer required, which substantially simplifies, on the one hand, the configuration of the axle carrier 1 and lining 5 and, on the other hand, their assembly. In this context, a further simplification of the solution is represented, namely that the two lining portions 5 of the longitudinal sides 3 can be joined together in one piece to form a single component, the connecting portions fully covering the transverse bridges 9 of the axle carrier 1 which connect the longitudinal sides 3 thereof. A minimum number of lining parts with a maximum screening effect is thereby attained. The lining 5 is of skin-like, space-saving configuration conforming to the contour of the top side 4 of the axle carrier 1.

In order to avoid an uncontrolled discharge of the air heated by the engine waste heat to the outside, especially to regions of the vehicle which are relevant to the engine waste heat, it is especially advantageous if, as much as possible, all through-holes and openings in the axle carrier 1 are covered in a soundproof and heatproof manner. These are, more specifically, the track control arm opening 10 and the spring control arm opening 11 in the axle carrier 1, and an interspace 12 between the longitudinal member of the vehicle, to which the axle carrier 1 is fastened, and the axle carrier 1. The covering of a bearing 13 of the axle carrier 1 for an axle stabilizer, furthermore, is also of particular importance.

The protective lining 5 advantageously consists of a material having special heat-insulating properties. Favorably in terms of material, and in a production-friendly and assembly-friendly manner, the heat-insulating material of the lining 5 is also equipped with sound-insulating properties, so that multifunctional properties are anchored in a single lining part so as to save on both components and space. That is to say, the material must essentially be formed hard enough, and with low heat conductivity and high heat-absorption capacity, to provide sufficiently good heat insulation. On the other hand, however, it must be sufficiently soft to guarantee sound insulation. In particular, the lining 5 must not rattle against the axle carrier 1 whilst the vehicle is running. Materials which combine the two properties particularly favorably within themselves can be found amongst elastomer-modified thermoplastics, preferably polyamide (for example PA6/X-HI, EGR, 12-002N according to ISO 1874/1) or polyurethane, or in an elastomer-modified, two-component system with polyurethane. The material of the lining 5 can also consist of two interconnected plastics, plastics layers lying one on top of the other or plastics parts, the one plastic exhibiting the sound-insulating properties and the other plastic the heat-insulating properties. Care should here be taken to ensure that the plastic having the heat-insulating properties is disposed above the plastic having the sound-insulating properties for the properties to show to best advantage. It is also conceivable that a patchwork combination of the two material will prove effective, such that at those points on the axle carrier 1 at which only heat-insulating properties are demanded, the plastic with especially good heat insulation is predominantly or exclusively used, and where the engine waste heat is not within harmful limits, the plastic with excellent sound insulation properties is predominantly or exclusively used. In this context, the different materials can be spatially joined together within a single lining part or can be concentrated on separate lining parts.

It is, of course, possible to design the lining 5 as a coating of the axle carrier 1, which has production engineering advantages in terms of speed of manufacture. It has been shown in trials, however, that for a particularly good and effective result in terms of sound and heat installation, it is advantageous if the lining 5 is an independent component, which, with the exception of the fastening points 6 for fastening the lining 5 to the axle carrier 1, is distanced from the latter by an air gap 14. The width of the air gap 14 lies preferably in the region of around 2 mm. Should space so allow, it is conceivable on the top side of the lining 5 to design this with air chambers in order thereby to gain a further increase in heat and sound insulation.

If the heat insulation is particularly good, it is advantageously conceivable to dispense with the heat shields, normally applied in the engine compartment and consisting of aluminum plates, for the exhaust gas lines, thereby saving on costs and space. The inventive lining consisting of the aforementioned plastic, owing to its relatively smooth surface when acting as a chafing protection against the roughness and angularity of the axle carrier 1 relative to soft-material hoses and lines running in or along the engine compartment and conducting, for example, hydraulic oil or brake fluid, or forming electrical supply lines, offers a further extraordinary advantage. Those movements of hoses and lines which are conditioned by heat or by induced vibration can hence proceed in a harmless manner, with the prevention of fraying and possible consequent breakdown.

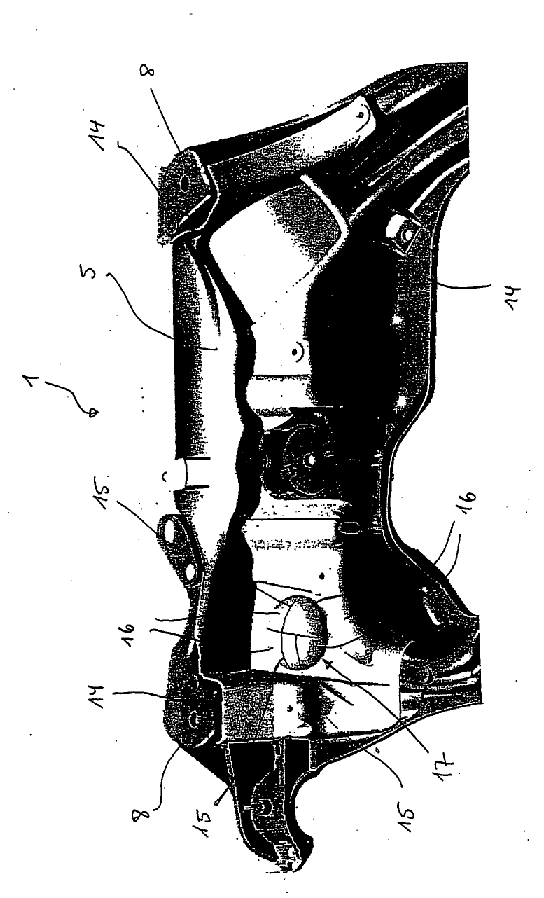

Unlike the version of the fully lined variant of the illustrative embodiment according to FIG. 1, FIG. 2 shows a part-lining 5 of the axle carrier 1. This part-lining can be used, for example, in less powerful engines, since there only the basic regions of the axle carrier 1 which are relevant to waste heat and sound insulation are required to be covered. In FIG. 2, the air gap 14 can be seen particularly clearly at the fastening points 8. Both in the variant according to FIG. 1 and in that according to FIG. 2, the lining 5 is attached to the axle carrier 1 prior to the mounting of the engine on the axle carrier 1. For the subsequent fitting of the engine, it may here prove difficult, because of poor accessibility, to carry out screwing and/or clamping connections effectively. In order to solve this problem, at points of covered openings 10 and 11 in the axle carrier 1, on a circular surface, the lining 5 is provided with diametrical slots 15. The slotted leaves 16 which are hereupon formed are of resiliently elastic configuration, so that the lining 5, for assembly purposes, can easily be pierced with an assembly tool and, following the assembly and tool withdrawal, passes automatically into the closing position with no loss of functionality in terms of heat insulation and sound insulation. This resetting effect can be obtained merely by adopting the construction measure of forming a slotted, domed elevation 17 over the circular surface. The diametrical slotting ensures equal spring strengths of the slotted leaves 16, so that, when the tool is fed through to the assembly point and away from the assembly point, no wedging or jamming occurs. In place of a larger elevation 17, two smaller elevations 17, disposed one beside the other, can also in practice be formed.

1. A vehicle having an internal combustion engine and an axle carrier on which the engine is mounted, wherein the axle carrier (1) has on its top side (4) at least one protective lining (5).

2. The vehicle as claimed in claim 1, wherein the lining (5) is a material with heat-insulating properties.

3. The vehicle as claimed in claim 1, wherein the material of the lining (5) has sound-insulating properties.

4. The vehicle as claimed in claim 1, wherein the material of the lining (5) comprises an elastomer-modified thermoplastic.

5. The vehicle as claimed in claim 1, wherein the material of the lining (5) comprises two interconnected plastics, the one plastic exhibiting sound-insulating properties and the other plastic exhibiting heat-insulating properties.

6. The vehicle as claimed in claim 5, wherein the plastic having the heat-insulating properties is disposed above the plastic having the sound-insulating properties.

7. The vehicle as claimed in claim 1, wherein wherein the lining (5) covers a track control arm opening (10) in the axle carrier.

8. The vehicle as claimed in claim 1, wherein wherein the lining (5) covers a spring control arm opening (11) in the axle carrier (1).

9. The vehicle as claimed in claim 1, wherein wherein the lining (5) covers an interspace (12) between the axle carrier (1) and a longitudinal member of the vehicle to which the axle carrier (1) is fastened.

10. The vehicle as claimed in claim 1, wherein the lining covers a bearing (13) of the axle carrier (1) for an axle stabilizer.

11. The vehicle as claimed in claim 1, wherein that the linings (5) of the individual cover points are joined together in one piece.

12. The vehicle as claimed in claim 1, wherein the two longitudinal sides (3) of the axle carrier (1), extending parallel to the vehicle longitudinal axis, are fully covered by means of the lining (5), with the exception of the fastening points (8) for fastening to the longitudinal member and the engine mount (2).

13. The vehicle as claimed in claim 12, wherein the two lining portions covering the longitudinal sides (3) of the axle carrier (1) are joined together in such a way that they form a single component, the connecting portions fully covering the transverse bridges (9) of the axle carrier (1), which join its longitudinal sides (3).

14. The vehicle as claimed in claim 1, wherein the lining (5), with the exception of the fastening points (6) for fastening the lining (5) to the axle carrier (1), is distanced from the latter by an air gap (14).

15. The vehicle as claimed in claim 1, wherein the lining (5) is formed by a coating of the axle carrier (1).

16. The vehicle as claimed in claim 1, wherein the lining (5) is of skin-like configuration conforming to the contour of the top side (4) of the axle carrier (1).

17. The vehicle as claimed in claim 1, wherein air chambers are formed on the top side of the lining (5).

18. The vehicle as claimed in claim 1, wherein at points of covered openings (10, 11) in the axle carrier (1), on a circular surface, the lining (5) is provided with diametrical slots (15), with slotted leaves (16) which are hereupon formed being of resiliently elastic configuration.

19. The vehicle as claimed in claim 1, wherein the material of the lining (5) comprises polyamide or polyurethane.
